(19) United States
(12) Patent Application Publication
(10) Pub. No.: US 2025/0276401 A1
(43) Pub. Date: Sep. 4, 2025

(54) Resistance welding device having a stationary electrode and a movable electrode between a working position and two distinct resting positions

(71) Applicant: GYS, SAINT-BERTHEVIN (FR)

(72) Inventors: Bruno BOUYGUES, PARIS (FR); Arnaud FRISON, CHATILLON SUR SEINE (FR); Mickael GABILLARD, MONTIGNE LE BRILLANT (FR)

(21) Appl. No.: 19/068,541

(22) Filed: Mar. 3, 2025

(30) Foreign Application Priority Data
Mar. 4, 2024 (FR) 2402129

(51) Int. Cl. B23K 11/31; B23K 11/11; B23K 11/30

(52) U.S. Cl. CPC B23K 11/312; B23K 11/115; B23K 11/3009

(57) ABSTRACT

A resistance welding device. The device includes: a clamp intended to support an arm including a first part supporting a stationary electrode and a second part supporting a translationally movable electrode, the electrodes being intended to be passed through by an electrical current and to clamp metal elements in order to weld them The movable electrode is configured to move between a working position, wherein the electrodes clamp the metal elements to be welded, and two opening positions making it possible to insert, between the electrodes disposed opposite one another, the metal elements to be welded.

### CROSS REFERENCE TO RELATED APPLICATION

The present application claims priority to French Patent Application No. FR 2402129, filed Mar. 4, 2024, the content of which is hereby incorporated herein by reference in its entirety.

### FIELD OF THE DISCLOSURE

The field of the disclosure is that of resistance welding devices.

The disclosure relates more particularly to such devices including a clamp intended to support an arm that consists of a first part supporting a stationary electrode and a second part supporting a translationally movable electrode.

### PRIOR ART AND DRAWBACKS THEREOF

Resistance welding devices dispose of a means of generating very high electrical currents that pass through electrodes via electrical contacts contained in each of them. The electrodes are configured to clamp materials, particularly metal elements, in view of welding them by particularly producing a spot weld.

When the spot weld is produced, the passage of very high currents between the electrodes heats up the materials given the greater electrical resistance thereof than that of the electrodes. For example, the very high currents that pass through the electrodes are between 1,000 A and 15,000 Amperes.

Spot welding devices are known that are provided with a block including a clamp intended to support an arm, for example in a ‘C’ shape, including a first part supporting a stationary electrode and a second part supporting a translationally movable electrode. Current welding devices comprise an actuator, for example containing a pneumatic cylinder. The use of such a pneumatic cylinder makes it possible to control and to print a linear motion to the movable electrode. This linear motion makes it possible, in a first direction, to bring the movable electrode closer to the stationary electrode in view of clamping, in a working position, the materials to be welded, the clamp being then in a closed position, and in a second direction opposite to the first direction, to move the movable electrode away from the stationary electrode in view of unclamping these materials, the clamp passing from the closed position to an open position.

When the clamp is open, blocking means block the movable electrode in a resting position away from the working position thereof.

Conventionally, the linear motion of the movable electrode from the resting position to the working position is engaged after activating a control button configured to place under overpressure a chamber of the pneumatic cylinder.

Once the spot weld has been produced, the movable electrode is configured to then move from the working position to the resting position after deactivating the control button for example, so as to induce a negative pressure in the chamber of the pneumatic cylinder that was then under overpressure. One drawback of these resistance welding devices resides in the fact that the distance that separates the working position from the resting position of the movable electrode is fixed. In particular, this distance is predefined and optimised depending on the geometries and thicknesses of the materials to be welded.

To overcome this drawback, resistance welding devices exist wherein it is possible to increase this distance by manually manipulating the movable electrode of the clamp further away from the stationary electrode, that is to say retracting the movable electrode. For example, the means for blocking the movable electrode in the resting position may comprise a clamping means, such as a clamping ring, on contact with which the movable electrode is blocked and cannot move further away from the stationary electrode. In particular, the clamping means is designed to, on the one hand, be manually clamped on the second portion of the arm in view of holding the movable electrode in the resting position thereof. On the other hand, following the manual unclamping of the clamping means, it is possible to act directly on the movable electrode, and particularly to move it further away from the stationary electrode before reclamping it manually in order to hold the movable electrode in a new resting position.

However, with such a clamping means, it is necessary for an operator to intervene manually on the movable electrode in order to move it in view of modifying the resting position thereof. Moreover, the clamping efficiency of such a clamping means inevitably degrades over time, in particular with the clamping-unclamping cycles.

### SUMMARY

An aspect of the present disclosure relates to a resistance welding device including a clamp intended to support an arm including a first part supporting a stationary electrode and a second part supporting a translationally movable electrode, the electrodes being intended to be passed through by an electrical current and to clamp metal elements in order to weld them, the movable electrode being configured to move between:
a working position wherein the electrodes clamp the metal elements to be welded,
a first opening position making it possible to insert, between the electrodes disposed opposite one another, the metal elements to be welded wherein the movable electrode is in a first resting position and located at a first distance from the stationary electrode,
a second opening position making it possible to insert, between the electrodes disposed opposite one another, the metal elements to be welded wherein the movable electrode is in a second resting position and located at a second distance from the stationary electrode, greater than the first distance,
   the welding device comprising means for blocking the movable electrode in the first resting position and actuating means intended to act on the blocking means to permit the motion of the movable electrode to the second resting position under the effect of return means.

The joint presence of the blocking means, the actuating means and the return means makes it possible to easily permit the motion of the movable electrode from the first resting position to the second resting position. In particular, the return means make it possible to ensure the automatic motion of the movable electrode from the first resting position to the second resting position without manual intervention on the movable electrode, but by acting on an actuation button configured to activate the actuation means.

In addition, the fact of allowing the clamp to be opened further makes it possible to insert, between the two electrodes, the metal elements, for example automotive body metal sheets, having thicknesses greater than the distance separating the working position of the movable electrode from the first resting position thereof wherein it is mechanically blocked if no external force is applied to the actuating means.

Moreover, when the metal elements to be welded comprise an obstacle, for example when the metal sheets for manufacturing the automotive body include a body element defined by a thickness greater than the distance separating the working position from the first resting position, it is thus possible to bypass it in order to produce a precise spot weld located on the other side of the obstacle. Advantageously, an aspect of the present disclosure includes the following features, taken alone or in combination:
the resistance welding device comprises a cylinder rod whereon the movable electrode is mounted to be translationally driven, the cylinder rod being integral with the return means configured to return the movable electrode from the working position to the first resting position, then to the second resting position when this motion is permitted; this makes it possible to facilitate the movement of the movable electrode while having a mechanism simple to implement; this also makes it possible to dispose of a single-action cylinder that comprises a single chamber capable of being placed, on the one hand, under overpressure in order to engage the movement of the electrode from the second resting position to the first resting position, and from the first resting position to the working position, and, on the other hand, under negative pressure in order to, in combination with the return means, engage the movement of the electrode from the working position to the first resting position, and from the first resting position to the second resting position;
the blocking means include a blocking latch provided with a blocking finger configured to cooperate with a stop arranged on the outer surface of the cylinder rod; this makes it possible to have blocking means that are easy to implement with the blocking latch that guarantees translational blocking of the cylinder from the first resting position to the second resting position when it cooperates with the stop;
the blocking latch is mounted pivoting about an axis of rotation between a blocking position wherein the blocking finger cooperates with the stop and a release position wherein the motion of the movable electrode to the second resting position is permitted; this makes it possible to have a mechanism for permitting the motion of the movable electrode that is simple to implement;
the actuating means include an unlocking lever configured to actuate the pivoting of the blocking latch; this makes it possible to manually switch between the blocking position and the release position.

### BRIEF DESCRIPTION OF THE FIGURES

Other features and advantages of the present disclosure will now appear in more detail within the scope of the following description of examples of embodiments given by way of illustrative and non-limiting examples to the appended figures that show:

FIG. 1 shows a schematic cross-sectional view of a clamp of a welding device including a movable electrode according to one example of embodiment, the movable electrode being in a first resting position;

FIG. 2 shows a schematic cross-sectional view of a clamp of a welding device including a movable electrode according to one example of embodiment, the movable electrode being in a working position;

FIG. 3 shows a schematic cross-sectional view of a clamp of a welding device including a movable electrode according to one example of embodiment, the movable electrode being in a second resting position;

FIG. 4 shows a schematic cross-sectional view centred on the means for blocking the movable electrode of a clamp of a welding device according to one example of embodiment, the blocking means being in a position blocking the motion of the movable electrode from the first resting position to the second resting position;

FIG. 5 shows a schematic cross-sectional view centred on the means for blocking the movable electrode of a clamp of a welding device according to one example of embodiment, the blocking means being in a position permitting the motion of the movable electrode from the first resting position to the second resting position;

FIG. 6 shows a front view of the movable electrode of a welding device according to one example of embodiment, wherein the blocking means are in a position blocking the motion of the movable electrode from the first resting position to the second resting position;

FIG. 7 shows a front view of the movable electrode of a welding device according to one example of embodiment, wherein the blocking means are in a position permitting the motion of the movable electrode between the first resting position and the second resting position.

### DETAILED DESCRIPTION

Unless otherwise specified, the same element appearing on different figures has a unique reference. An aspect of the present disclosure relates to a resistance welding device for welding metal elements together.

For example, the metal elements can take the form of metal sheets intended to be used in automotive body manufacturing.

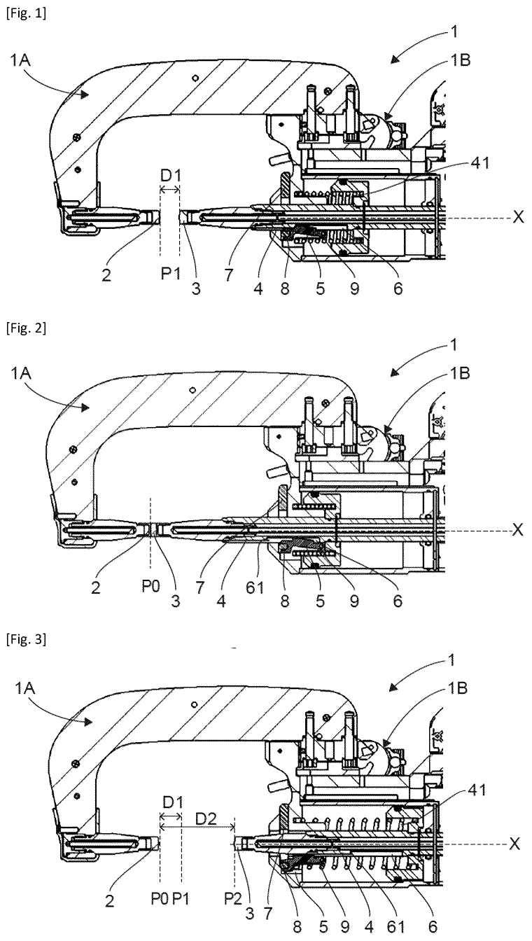

As illustrated in FIGS. 1 to 3, the welding device comprises a clamp 1. The clamp 1 includes an arm including two parts located opposite one another. A first part 1A ends with a stationary electrode 2 and a second part 1B ends with a movable electrode 3.

Preferably, the arm and clamp 1 assembly is held by an operator or attached to the end of a robot arm. The stationary electrode 2 and the movable electrode 3 are designed to be passed through by an electrical current in order to weld the metal elements clamped between the stationary electrode 2 and the movable electrode 3 by producing a spot weld. This electrical current passes through the two electrodes 2 and 3 particularly via electrical contacts contained in each of them.

Preferably, the movable electrode 3 is mounted on a cylinder rod 4. The cylinder is, in one example of embodiment, a single-action cylinder and defined by a predefined stroke length.

Preferably, the cylinder rod 4 is inserted into a cylinder wherein it slides. The cylinder rod 4 then carries at one end the movable electrode 3 and at the opposite end thereof a piston sliding in the cylinder. The movement of the movable electrode 3 is then carried out by the forward and backward motions of the cylinder.

Preferably, a chamber of the cylinder is disposed on the sliding piston side. The forward and backward motions of the cylinder are then engaged by alternately placing the chamber of the cylinder under fluid overpressure and under fluid negative pressure. For example, the fluid overpressure of the chamber of the cylinder is generated by pressurising a pneumatic fluid, such as compressed air, whereas the fluid negative pressure is, for its part, engaged by withdrawing a volume of compressed air contained in the chamber of the cylinder.

In this way, the movable electrode 3 is translationally driven by the cylinder rod 4 in a first direction along a longitudinal axis X and in a second direction, opposite to the first direction along the longitudinal axis X. Thus, the cylinder rod 4, on the one hand, advances in the first direction, when the chamber of the cylinder is placed under fluid overpressure, so that the movable electrode 3 and the stationary electrode 2 clamp the metal elements, and, on the other hand, moves back in the second direction, when the cylinder chamber is placed under fluid negative pressure, in order to release the movable electrode 3 from the metal elements and move it away from the stationary electrode 2 after any spot weld has been produced.

According to an aspect of the present disclosure, in order to translationally drive the cylinder rod 4 in the second direction, the latter is integral with return means configured to release the movable electrode 3 from the metal elements when the cylinder chamber is placed under fluid negative pressure. In particular, the return means make it possible to guarantee the translational movement of the cylinder rod 4 in the second direction when the cylinder chamber is placed under fluid negative pressure.

In one example of embodiment, the return means contain a return spring 41 integral with the sliding piston. Preferably, the return spring 41 is a tension spring. In particular, the sliding piston is mounted on the return spring 41 which, when the return spring 41 is relaxed, exerts a return force on the cylinder rod 4 so that it moves in the second direction when the cylinder chamber is placed under fluid negative pressure.

Preferably, the translational driving of the cylinder rod 4 in the first direction is engaged when an operator continuously presses a control button to actuate the supply of the cylinder chamber with compressed air in order to place it under fluid overpressure.

Preferably, the translational driving of the cylinder rod 4 in the second direction is engaged when the operator stops pressing the control button in order to place the cylinder chamber under fluid negative pressure. This makes it possible for the cylinder rod 4, under the effect of the return spring 41, to move back over the entire stroke length of the cylinder if this movement is permitted, that is to say if the cylinder rod is not in the meantime blocked in any position.

It should be noted that the assembly including the cylinder is designed in order to stabilise the position of the movable electrode 3 when the electrodes are either in contact with one another or in contact with the metal elements to be welded.

FIG. 1 shows the clamp 1 open according to a first opening position. In particular, the movable electrode 3 is here in a first resting position P1, wherein it is possible to insert, between the stationary electrode 2 and the movable electrode 3 then disposed opposite one another, the metal elements to be welded.

The movable electrode 3 is then located at a first distance D1 from the stationary electrode 2. The movable electrode 3 cannot move further away from the stationary electrode 2. Indeed, this distance is blocked by blocking means that will be described later. Preferably, the first distance D1 is less than the stroke length of the cylinder.

FIG. 2 shows the clamp 1 closed. The movable electrode 3 is here in a working position P0, wherein it is possible to produce the spot weld on the metal elements. The movable electrode 3 moves from the first resting position P1 to the working position P0 when the closing of the clamp 1 is engaged, that is to say when the cylinder chamber is placed under overpressure so that the cylinder rod 4 advances. The movable electrode 3 then moves closer to the stationary electrode 2 to stabilise in the working position P0.

It should be noted that the movable electrode 3 also moves from the working position P0, shown in FIG. 2, to the first resting position P1, shown in FIG. 1, when the opening of the clamp P1 is engaged. In particular, during this movement, the rod 4 of the cylinder moves back until the blocking means are locked.

After acting on the blocking means to unlock them, via actuation means that will be described later, the movable electrode 3 moves from the first resting position P1 to a second resting position P2 shown in FIG. 3. This movement is permitted by an operator when an over-opening of the clamp 1 is desired so as to open it further.

In particular, FIG. 3 shows the clamp 1 open according to the second opening position. In the second opening position, it is possible to insert, between the stationary electrode 2 and the movable electrode 3 then disposed opposite one another, metal elements to be welded defined by a thickness greater than the metal elements that could be inserted through the clamp 1 when the movable electrode 3 was in the first resting position P1.

It should be noted that in the second opening position, the movable electrode 3 is therefore located at a second distance D2 from the stationary electrode 2 which is greater than the first distance D1. Thus, when the cylinder chamber is placed under negative pressure in view of moving the cylinder rod 4 back under the effect of the return spring 41 integral with the sliding piston, the movable electrode 3 moves from the working position P0 to the first resting position P1, then to the second resting position P2 when this motion is permitted, that is to say when the cylinder rod 4 is not blocked by the blocking means.

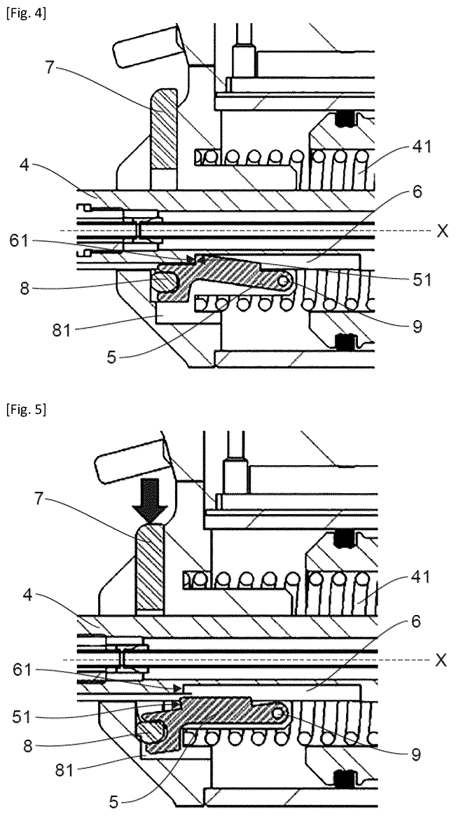

FIGS. 4 and 5 particularly show an example of embodiment of the blocking means. In particular, FIG. 4 shows the blocking means in a locking position, that is to say in a blocking position, whereas FIG. 5 shows the blocking means in an unlocking position, that is to say in a release position of the cylinder rod 4.

In particular, the blocking means here include a longitudinal groove 6 arranged on the outer surface of the cylinder rod 4 and along the longitudinal axis X thereof. Preferably, the longitudinal groove 6 is a key groove.

The blocking means further include a blocking latch 5 provided with a blocking finger configured to be inserted into the longitudinal groove 6 and to produce a slide connection with it.

In particular, the groove 6 includes a wall transverse to the longitudinal axis X forming a stop 61 in contact with a blocking surface 51 of the blocking finger. Preferably, the blocking surface 51 of the blocking finger is a flat surface.

Preferably, the blocking latch 5 is integral with the actuating means described later. The actuating means are configured to lower the blocking latch 5 so as to pass from the blocking position as illustrated in FIG. 4, to the release position as illustrated in FIG. 5 when a force is exerted on the latter (the force being represented by an arrow in FIG. 5).

In particular, the actuating means are configured to hold, when they are not actuated, the blocking latch 5 raised so that the blocking finger is flush with a sliding surface of the groove 6 when it is opposite the blocking finger. In this way, the stop 61 moves translationally along the longitudinal axis X while the blocking finger is held in contact with the sliding surface of the groove 6 when the movable electrode 3 moves between the working position P0 and the first resting position P1. Thus, when the blocking surface 51 of the blocking finger is in contact with the stop 61, the movement of the movable electrode 3 from the first resting position P1 to the second resting position P2 is blocked. To permit the movement of the cylinder rod 4 backwards in view of moving the movable electrode 3 from the first resting position P1 to the second resting position P2, an operator exerts a force on the actuating means to lower the blocking latch 5 in order to remove the blocking finger from the groove 6. This makes it possible to avoid contact of the blocking surface 51 of the blocking finger with the stop 61.

According to one example of embodiment, the blocking latch 5 is oblong in shape and then includes two ends. Thus, to raise it and to lower it, the first end thereof is mounted pivoting about an axis of rotation 9 formed by a pivot link connecting the first end of the blocking latch 5 and the second portion of the arm.

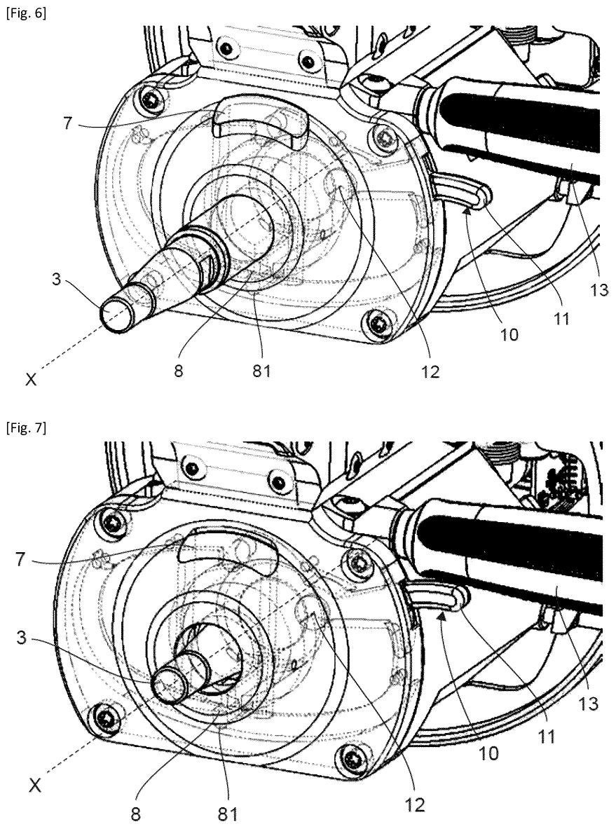

The second end of the blocking latch 5 is, for its part, connected to the actuating means that include, according to an example of embodiment illustrated in FIGS. 6 and 7, a slider 7, an unlocking lever 10 ending, preferably, with an unlocking finger 11, and a retaining spring configured to hold the blocking latch 5 raised when the unlocking lever 10 is not actuated. It should be noted that the unlocking finger 11 can take the form of an actuation button of any type.

Preferably, the slider 7 is oblong in shape and then includes two ends. The slider 7 also includes an opening through which the movable electrode 3 is introduced to make the translational movement thereof possible between the various positions mentioned above. A first end of the slider 7 is connected to the second end of the blocking latch 5, for example via a connecting element 8, which is either an integral part of the slider 7 or of the blocking latch 5, or which is an element in its own right. Here, the connecting element 8 is an extension of the first end of the slider that slots into the second end of the blocking latch 5 in order to create a movable connection between the blocking latch 5 and the slider 7.

According to one example of embodiment, the unlocking lever 10 comprises a rod including a first end and a second end, the ends being inclined towards one another according to an inclination angle, for example, greater than 90°. Preferably, the first end of the rod inserts into a second end of the slider 7, and the second end of the rod ends with the unlocking finger 11. The rod is pivotingly mounted about a pivot connection 12 made, preferably at the inclination angle, so as to set the slider 7 in motion.

In particular, the slider 7 is configured to move translationally in a direction substantially transverse to the longitudinal axis X between the blocking position and the release position of the blocking means. In particular, when the slider 7 is in a raised position as illustrated in FIGS. 4 and 6, the blocking finger of the blocking latch 5 is inserted into the groove 6. The movable electrode 3 is then blocked in the first resting position P1. When the slider 7 is in a lowered position as illustrated in FIGS. 5 and 7, the blocking finger is removed from the groove 6. In this situation, a part of the first end of the slider 7 and/or a part of the second end of the latch 5, and optionally also the connecting element 8, are housed in a suitable housing 81 and made in the second part 1B of the arm of the clamp 1. The movable electrode 3 is then brought into the second resting position P2. The slider 7 passes from the raised position thereof to the lowered position thereof when, preferably, the operator manually actuates the unlocking of the blocking means by exerting, for example, a force on the unlocking finger 11. The slider 7 passes from the lowered position thereof to the raised position thereof by exerting a force applied by a return element. The slider 7 is held in the raised position thereof by the force applied by the return element when no force is exerted directly on the unlocking finger 11. In one example of embodiment, the rod of the unlocking lever 10 is mounted on the retaining spring which is preferably a compression spring. Thus, the pressure of the retaining spring, when the retaining spring is compressed, exerts a force on the slider 7 to naturally raise it and thus oppose the movement thereof from the raised position thereof to the lowered position thereof. This makes it possible to hold the blocking finger of the blocking latch 5 in the groove 6, in order to block the rearward movement of the cylinder rod 4, when no force is exerted on the unlocking finger 11. Preferably, the unlocking lever 10 is connected to the second part 1B of the arm of the clamp 1 by the pivot connection 12. Thus, the slider 7 moves from the raised position thereof to the lowered position thereof when the operator exerts a rotational force on the unlocking finger 11. For example, the rotational force that the operator must exert on the unlocking finger 11 to unlock the blocking means is a force exerted counterclockwise. It should be noted that the unlocking finger 11 then moves naturally, via the force exerted by the retaining spring, in a clockwise direction to regain the equilibrium position thereof, that is to say the position thereof when the slider 7 is in the raised position thereof.

It should be noted that when the unlocking finger 11 is in the equilibrium position thereof, the blocking and actuating means are sufficiently rigid to not deform.

Moreover, it is indicated that the clamp 1 has a gripping and handling means such as a handle 13, possibly removable, attached to the second part 1B of the arm of the clamp 1.

The clamp 1 described above has the advantage of being able to open according to two opening positions: an opening position corresponding to the first resting position P1 of the movable electrode 3, and an over-opening position corresponding to the second resting position P2 of the movable electrode 3.

This makes it possible to adapt the clamp 1 to thicknesses of metal elements greater than the distance separating the electrodes 2, 3 in the first resting position P1, but also to simplify the positioning of the electrodes on either side of metal elements to be welded when access to these elements is reduced and difficult.

According to an aspect of the present disclosure, it is possible to carry out this over-opening without manually manipulating either of the electrodes or using a pneumatic circuit.

An aspect of the present disclosure proposes a welding device provided with a linear motion arm for ‘C’ motion spot welding clamps.

The welding device has a mechanism making it possible, on the one hand, to move the movable electrode between the clamping position, that is to say the working position, and the resting position, and on the other hand, to move the movable electrode from the first resting position to a withdrawal position located at a distance away from the working position greater than the distance away separating the working position from the resting position.

In addition, the movement of the movable electrode between the resting position thereof and the withdrawal position thereof is carried out by eliminating the need for manual manipulation of the movable electrode.

Although the present disclosure has been described with reference to the particular embodiments illustrated, it is in no way limited by these embodiments but is only limited by the appended claims. It should be noted that changes or modifications may be made by the person skilled in the art.

1. A resistance welding device comprising:
a clamp to support an arm including a first part supporting a stationary electrode and a second part supporting a translationally movable electrode, the electrodes being configured to be passed through by an electrical current and positioned to clamp metal elements in order to weld them, the movable electrode being movable between:
a working position wherein the electrodes clamp the metal elements to be welded,
a first opening position making it possible to insert, between the electrodes disposed opposite one another, the metal elements to be welded wherein the movable electrode is in a first resting position and located at a first distance from the stationary electrode, and
a second opening position making it possible to insert, between the electrodes disposed opposite one another, the metal elements to be welded wherein the movable electrode is in a second resting position and located at a second distance from the stationary electrode, greater than the first distance;
a block, which blocks the movable electrode in the first resting position; and
an actuator which acts on the block to permit the movement of the movable electrode to the second resting position under an effect of a return element.

2. The resistance welding device according to claim 1, comprising a cylinder rod whereon the movable electrode to be translationally driven is mounted, the cylinder rod being integral with the return element configured to return the movable electrode from the working position to the first resting position, then to the second resting position when the movement is permitted.

3. The resistance welding device according to claim 2, wherein the block comprises a blocking latch provided with a blocking finger configured to cooperate with a stop arranged on an outer surface of the cylinder rod.

4. The resistance welding device according to claim 3, wherein the blocking latch is mounted pivotable about an axis of rotation between a blocking position wherein the blocking finger cooperates with the stop and a release position wherein the movement of the movable electrode to the second resting position is permitted.

5. The resistance welding device according to claim 4, wherein the actuator includes an unlocking lever configured to actuate pivoting of the blocking latch.
